(19) United States
(12) Patent Application Publication
(10) Pub. No.: US 2025/0118110 A1
(43) Pub. Date: Apr. 10, 2025

(54) MANAGEMENT APPARATUS, MANAGEMENT METHOD, AND COMPUTER-READABLE MEDIUM

(71) Applicant: NEC Corporation, Minato-ku, Tokyo (JP)

(72) Inventors: Jianquan LIU, Tokyo (JP); Ryo KAWAI, Tokyo (JP); Noboru YOSHIDA, Tokyo (JP)

(73) Assignee: NEC Corporation, Minato-ku, Tokyo (JP)

(21) Appl. No.: 18/729,157

(22) PCT Filed: Feb. 7, 2022
(86) PCT No.: PCT/JP2022/004698

§ 371 Date: Jul. 15, 2024

(51) Int. Cl. G06V 40/20; G06Q 50/26; G06V 20/52

(52) U.S. Cl. CPC G06V 40/23; G06Q 50/265; G06V 20/52

(57) ABSTRACT

A management apparatus (10) includes a motion detection unit (11), a related image specifying unit (12), a determination unit (13), and an output unit (14). The motion detection unit (11) detects a predetermined motion performed by a person from image data of an image obtained by capturing a predetermined place including the person. The related image specifying unit (12) specifies a predetermined related image related to the safety of the person. The determination unit (13) determination means determines whether or not the person is in a safe situation based on the detected motion and a positional relationship between the person performing the motion and the related image. The output unit (14) outputs determination information including a result of the determination performed by the determination means.

### TECHNICAL FIELD

The present disclosure relates to a management apparatus, a management method, and a computer-readable medium.

### BACKGROUND ART

Various techniques have been developed to keep workers safe in predetermined spaces such as construction sites.

For example, Patent Literature 1 discloses a technique for determining danger after obtaining work site measurement data by separating movements of workers and movements of non-workers at a work site.

Patent Literature 2 discloses a technique for acquiring an operating state of a facility, detecting a position and an orientation of a worker, and determining that a combination of the operating state of the facility and the position and the orientation of the worker is inappropriate in a case of a predetermined combination.

Patent Literature 3 discloses a technique for acquiring identification information of each of a plurality of workers simultaneously present in a dangerous area and executing a safety operation when at least one of the plurality of workers enters a detection area set for at least one worker.

### CITATION LIST

### Patent Literature

Patent Literature 1: Japanese Unexamined Patent Application Publication No. 2019-101549
Patent Literature 2: Japanese Unexamined Patent Application Publication No. 2019-191748
Patent Literature 3: Japanese Unexamined Patent Application Publication No. 2018-202531

### SUMMARY OF INVENTION

### Technical Problem

However, since workers in the field perform various motions, it is difficult to comprehensively manage safety by integrating diverse perspectives. In addition, simpler techniques are required to keep workers safe.

In view of the aforementioned problems, an object of the present disclosure is to provide a management apparatus and the like that can efficiently and easily manage worker safety.

### Solution to Problem

A management apparatus according to an aspect of the present disclosure includes a motion detection means, a related image specifying means, a determination means, and an output means. The motion detection means detects a predetermined motion performed by a person from an image obtained by capturing a predetermined place including the person. The related image specifying means specifies a related image showing a predetermined object or area related to safety of the person from image data of the image obtained by capturing the predetermined place. The determination means determines whether or not the person is in a safe situation based on the detected motion and a positional relationship between the person performing the motion and the object or the area indicated by the related image. The output means outputs determination information including a result of the determination performed by the determination means.

In a management method according to an aspect of the present disclosure, a computer executes the following processing. The computer detects a predetermined motion performed by a person from image data of an image obtained by capturing a predetermined place including the person. The computer specifies a related image showing a predetermined object or area related to safety of the person from the image obtained by capturing the predetermined place. The computer determines whether or not the person is in a safe situation based on the detected motion and a positional relationship between the person performing the motion and the object or the area indicated by the related image. The computer outputs determination information including a result of the determination.

A computer-readable medium according to an aspect of the present disclosure stores a program for causing a computer to execute the following management method. The computer detects a predetermined motion performed by a person from an image obtained by capturing a predetermined place including the person. The computer specifies a related image showing a predetermined object or area related to safety of the person from image data of the image obtained by capturing the predetermined place. The computer determines whether or not the person is in a safe situation based on the detected motion and a positional relationship between the person performing the motion and the object or the area indicated by the related image. The computer outputs determination information including a result of the determination.

### Advantageous Effects of Invention

According to the present disclosure, it is possible to provide a management apparatus or the like that can efficiently and easily manage worker safety.

### BRIEF DESCRIPTION OF DRAWINGS

FIG. 1 is a block diagram of a management apparatus according to a first example embodiment.

FIG. 2 is a flowchart illustrating a management method according to the first example embodiment.

FIG. 3 is a diagram illustrating the overall configuration of a management system according to a second example embodiment.

FIG. 4 is a diagram illustrating skeleton data extracted from image data.

FIG. 5 is a diagram for explaining a registered motion database according to the second example embodiment.

FIG. 6 is a diagram for explaining a first example of a registered motion according to the second example embodiment.

FIG. 7 is a diagram for explaining a second example of the registered motion according to the second example embodiment.

FIG. 8 is a diagram for explaining a safety standard database according to the second example embodiment.

FIG. 9 is a diagram illustrating a first example of an image captured by a camera.

FIG. 10 is a diagram illustrating skeleton data extracted by the management apparatus.

FIG. 11 is a diagram illustrating a related image specified by the management apparatus.

FIG. 12 is a diagram in which skeleton data and a related image are superimposed on an image captured by a camera.

FIG. 13 is a diagram illustrating a second example of an image captured by a camera.

FIG. 14 is a diagram illustrating a third example of an image captured by a camera.

FIG. 15 is a diagram illustrating a fourth example of an image captured by a camera.

FIG. 16 is a diagram illustrating the overall configuration of a management system according to a third example embodiment.

FIG. 17 is a block diagram of an authentication apparatus according to the third example embodiment.

FIG. 18 is a flowchart illustrating a management method according to the third example embodiment.

FIG. 19 is a block diagram illustrating the hardware configuration of a computer.

### EXAMPLE EMBODIMENT

Hereinafter, the present disclosure will be described through example embodiments, but the disclosure according to the claims is not limited to the following example embodiments. In addition, not all the configurations described in the example embodiments are essential as means for solving the problem. In the diagrams, the same elements are denoted by the same reference numerals, and repeated description is omitted as necessary.

### First Example Embodiment

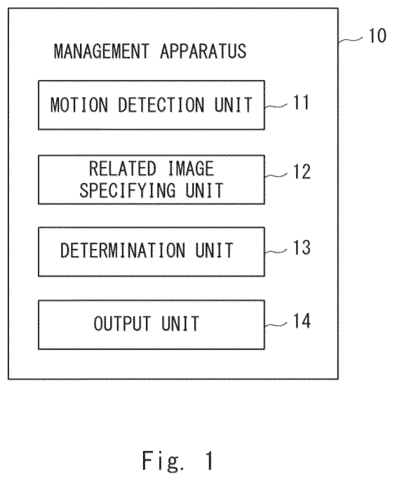

First, a first example embodiment of the present disclosure will be described. FIG. 1 is a block diagram of a management apparatus 10 according to the first example embodiment. The management apparatus 10 illustrated in FIG. 1 analyzes, for example, the posture or movement of a person included in an image captured by a camera installed at a predetermined work site, and manages whether or not the person is performing work or the like satisfying a predetermined safety standard.

The management apparatus 10 includes a motion detection unit 11, a related image specifying unit 12, a determination unit 13, and an output unit 14 as main components. In addition, in the present disclosure, “posture” refers to a form in at least a part of a body, and “motion” refers to a state of taking a predetermined posture along time. The “motion” is not limited to a case where the posture changes, and includes a case where a constant posture is maintained. Therefore, simply referring to “motion” may include a posture.

The motion detection unit 11 detects a predetermined motion performed by a person from image data of an image obtained by capturing a predetermined place including the person. The image data is image data according to a plurality of consecutive frames obtained by capturing a person performing a series of motions. The image data is, for example, image data according to a predetermined format such as H. 264 or H. 265. That is, the image data may be a still image or a moving image.

The predetermined motion detected by the motion detection unit 11 is estimated from, for example, the image of the body of the person extracted from the image data. The motion detection unit 11 detects that the person is performing predetermined work from the image of the body of the person. It is preferable that the predetermined work is, for example, a pattern of a preset work and may be performed at a work site.

The related image specifying unit 12 specifies a predetermined related image related to the safety of a person. The predetermined related image is set in advance, and may include, for example, a helmet, gloves, safety shoes, a belt, and the like worn by the worker. The predetermined related image may be an image related to a tool, a heavy machine, or the like used by the worker. The predetermined related image may be an image related to the facility, the passage, and the preset area used by the worker. The related image specifying unit 12 may specify a related image by recognizing the above-described image from the image captured by the camera. In addition, the related image specifying unit 12 may specify a predefined area superimposed on the image captured by the camera.

The determination unit 13 determines whether or not the person included in the image captured by the camera is in a safe situation. When making this determination, the determination unit 13 refers to the motion detected by the motion detection unit 11. When making this determination, the determination unit 13 calculates or refers to the positional relationship between the person performing the detected motion and the related image specified by the related image specifying unit 12.

The positional relationship is, for example, a distance between the person related to the detected motion and the related image. In addition, the positional relationship may indicate, for example, whether or not the related image is located at a predetermined position of the body of the person related to the detected motion. The positional relationship may indicate whether or not the person related to the detected motion is included in the related image as an area set in advance.

The determination unit 13 may calculate or refer to the positional relationship by analyzing an angle of view, an angle, or the like of the image from a predetermined object or landscape included in the image captured by the camera. In this case, the positional relationship may correspond to an actual three-dimensional space according to the captured image. The positional relationship may be calculated by estimating a three-dimensional space in a pseudo manner in the captured image. The positional relationship may be a positional relationship on a plane of the captured image. The determination unit 13 may calculate or refer to the above-described positional relationship by setting an angle of view, an angle, or the like of an image captured by the camera in advance.

The output unit 14 outputs determination information including a result of the determination performed by the determination unit 13. In this case, the determination information may indicate that the person whose motion has been detected is safe as a result of the determination, or may indicate that the person whose motion has been detected is not safe or is dangerous. The output unit 14 may output the above-described determination information to, for example, a display device (not illustrated) included in the management apparatus 10. The output unit 14 may output the above-described determination information to an external apparatus communicably connected to the management apparatus 10.

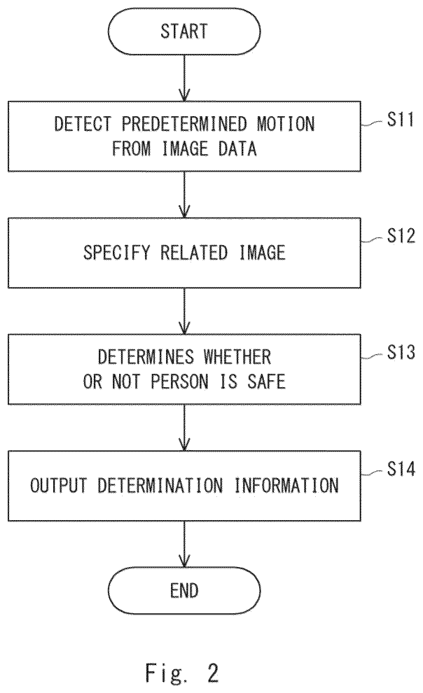

Next, processing performed by the management apparatus 10 will be described with reference to FIG. 2. FIG. 2 is a flowchart illustrating a management method according to the first example embodiment. The flowchart illustrated in FIG. 2 is started when the management apparatus 10 acquires image data, for example.

First, the motion detection unit 11 detects a predetermined motion performed by a person from image data of an image obtained by capturing a predetermined place including the person (step S11). When a predetermined motion performed by the person is detected, the motion detection unit 11 supplies information regarding the detected motion to the determination unit 13.

Then, the related image specifying unit 12 specifies a predetermined related image related to the safety of the person (step S12). The related image specifying unit 12 supplies information regarding the specified related image to the determination unit 13.

Then, the determination unit 13 determines whether or not the person is safe from the detected motion and the positional relationship between the person who is performing the motion and the related image (step S13). When determination information including the determination result is generated, the determination unit 13 supplies the generated determination information to the output unit 14.

Then, the output unit 14 outputs the determination information including the determination result to a predetermined output destination (step S14). When the determination information is output from the output unit 14, the management apparatus 10 ends a series of processing.

In addition, in the above-described processing, the order of steps S11 and S12 may be reversed, or steps S11 and S12 may be executed simultaneously or may be executed in parallel.

Although the first example embodiment has been described above, the configuration of the management apparatus 10 is not limited to the above-described configuration. For example, the management apparatus 10 includes a processor and a storage device as components (not illustrated). Examples of the storage device include a storage device including a non-volatile memory such as a flash memory or a solid state drive (SSD). In this case, the storage device included in the management apparatus 10 stores a computer program (hereinafter, also simply referred to as a program) for executing the above-described management method. In addition, the processor reads a computer program from the storage device into a buffer memory such as a dynamic random access memory (DRAM), and executes the program.

Each component of the management apparatus 10 may be implemented by dedicated hardware. In addition, some or all of the components may be implemented by general-purpose or dedicated circuitry, a processor, and the like, or a combination thereof. These may be implemented by a single chip or may be implemented by a plurality of chips connected to each other through a bus. Some or all of the components of each apparatus may be implemented by a combination of the above-described circuit and the like and a program. In addition, as the processor, a central processing unit (CPU), a graphics processing unit (GPU), a field-programmable gate array (FPGA), and the like can be used. In addition, the description regarding the configuration described herein can also be applied to other apparatuses or systems described below in the present disclosure.

In addition, when some or all of the components of the management apparatus 10 are implemented by a plurality of information processing apparatuses, circuits, and the like, the plurality of information processing apparatuses, circuits, and the like may be arranged in a centralized manner or in a distributed manner. For example, the information processing apparatuses, the circuits, and the like may be implemented in the form of a client server system, a cloud computing system, or the like in which these are connected to each other through a communication network. In addition, the function of the management apparatus 10 may be provided in a software as a service (SaaS) format. In addition, the above-described method may be stored in a computer-readable medium to cause a computer to perform the method.

As described above, according to the present example embodiment, it is possible to provide a management apparatus and the like that can efficiently and easily manage the safety of the worker.

### Second Example Embodiment

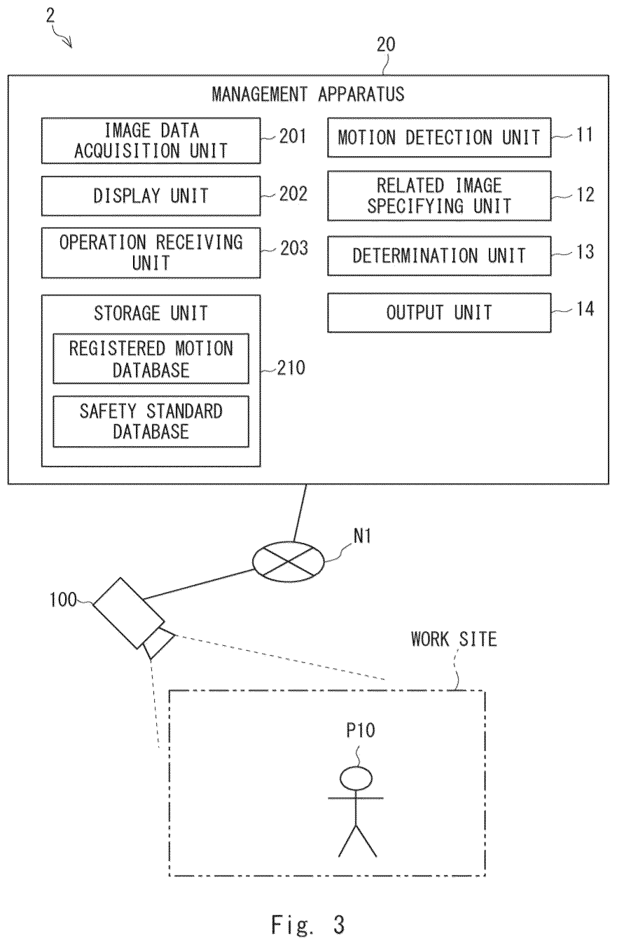

Next, a second example embodiment of the present disclosure will be described. FIG. 3 is a diagram illustrating the overall configuration of a management system 2 according to the second example embodiment. The management system 2 includes a management apparatus 20 and a camera 100. The management apparatus 20 and the camera 100 are communicably connected to each other through a network N1.

The camera 100 may be referred to as an imaging apparatus. The camera 100 includes an objective lens and an image sensor, and captures an image of a work site installed every predetermined period. At the work site captured by the camera 100, for example, a person P10 who is a worker is present. The camera 100 captures at least a part of the body of the person P10 by imaging the work site.

The camera 100 generates image data corresponding to each captured image, and sequentially supplies the image data to the management apparatus 20 through the network N1. The predetermined period is, for example, 1/15 second, 1/30 second, or 1/60 second. The camera 100 may have a function such as panning, tilting, or zooming.

The management apparatus 20 is a computer apparatus having a communication function, such as a personal computer, a tablet PC, or a smartphone. The management apparatus 20 includes an image data acquisition unit 201, a display unit 202, an operation receiving unit 203, and a storage unit 210 in addition to the configuration described in the first example embodiment.

The motion detection unit 11 according to the present example embodiment extracts skeleton data from the image data. More specifically, the motion detection unit 11 detects an image area (body area) of the body of the person from the frame image included in the image data, and extracts (for example, cuts out) the image area as a body image. Then, the motion detection unit 11 extracts skeleton data of at least a part of the body of the person based on the characteristics of joints and the like of the person recognized in the body image using a skeleton estimation technique using machine learning. The skeletal information is information including a “key point” that is a characteristic point such as a joint and a “bone link” indicating a link between the key points. The motion detection unit 11 may use, for example, a skeleton estimation technique such as OpenPose. In the present disclosure, the bone link described above may be simply referred to as a “bone”. The bone means a pseudo skeleton.

In addition, the motion detection unit 11 detects a predetermined posture or motion from the extracted skeleton data of the person, and compares the skeleton data related to the searched registered motion with the extracted skeleton data of the person. When detecting the posture or the motion, the motion detection unit 11 searches for the registered motion registered in a registered motion database stored in the storage unit 210. Then, when the skeleton data of the person is similar to the skeleton data related to the registered motion, the motion detection unit 11 recognizes the skeleton data as a predetermined posture or motion. That is, when a registered motion similar to the skeleton data of the person is detected, the motion detection unit 11 recognizes the motion related to the skeleton data as a predetermined posture or motion in association with the registered motion. That is, the motion detection unit 11 recognizes the type of the motion of the person by associating the skeleton data of the person with the registered motion.

In the above-described similarity determination, the motion detection unit 11 detects the posture or the motion by calculating the similarity of the forms of elements forming the skeleton data. As a component of the skeleton data, a pseudo joint point or a skeleton structure for indicating the posture of the body is set. The forms of elements forming the skeleton data can also be referred to as, for example, a relative geometric relationship of positions, distances, angles, and the like of other key points or bones when a predetermined key point or bone is used as a reference. Alternatively, the forms of elements forming the skeleton data can also be, for example, one integrated form formed by a plurality of key points or bones.

The motion detection unit 11 analyzes whether or not the relative forms of the components are similar between the two pieces of skeleton data to be compared. At this time, the motion detection unit 11 calculates a similarity between the two pieces of skeleton data. When calculating the similarity, the motion detection unit 11 can calculate the similarity using, for example, a feature amount calculated from the components included in the skeleton data.

In addition, the calculation target of the motion detection unit 11 may be, instead of the similarity, a similarity between a part of the extracted skeleton data and skeleton data related to the registered motion, a similarity between the extracted skeleton data and a part of the skeleton data related to the registered motion, or a similarity between a part of the extracted skeleton data and a part of the skeleton data related to the registered motion.

In addition, the motion detection unit 11 may calculate the similarity described above by directly using the skeleton data or indirectly using the skeleton data. For example, the motion detection unit 11 may convert at least a part of the skeleton data into another format and calculate the similarity described above using the converted data. In this case, the similarity may be the similarity itself between the converted pieces of data, or may be a value calculated using the similarity between the converted pieces of data.

The conversion method may be normalization of the image size according to the skeleton data, or may be conversion into a feature amount using an angle (that is, the degree of bending of the joint) formed by the skeleton structure. Alternatively, the conversion method may be a three-dimensional posture converted by a trained model of machine learning trained in advance.

With the above-described configuration, the motion detection unit 11 according to the present example embodiment detects a motion similar to the predetermined registered motion. The predetermined registered motion is, for example, information regarding a typical work motion performed by a person at a work site. When the detected motion is similar to the predetermined registered motion, the motion detection unit 11 supplies a signal indicating that the motion is similar to the registered motion to the determination unit 13.

In addition, as described above, the motion detection unit 11 according to the present example embodiment detects a motion from skeleton data regarding the structure of the body of a person extracted from image data regarding an image including the person. That is, the motion detection unit 11 extracts the image of the body of the person P10 from the image data, and estimates the pseudo skeleton related to the extracted structure of the body of the person. In addition, in this case, the motion detection unit 11 detects the motion by comparing the skeleton data related to the motion with the skeleton data as the registered motion based on the forms of the elements forming the skeleton data.

In addition, the motion detection unit 11 may detect a posture or a motion from skeleton data extracted from one piece of image data. The motion detection unit 11 may detect a motion from posture changes extracted in time series from each of a plurality of pieces of image data captured at a plurality of different times. That is, the motion detection unit 11 detects a posture change of the person P10 from a plurality of frames. With such a configuration, the management apparatus 20 can flexibly analyze the motion in accordance with the change state of the posture or the motion to be detected. Also in this case, the motion detection unit 11 can use the registered motion database.

The related image specifying unit 12 according to the present example embodiment specifies a predetermined object worn on the body of the person as a related image. The predetermined object worn on the body of the person is, for example, a helmet, a safety belt, or the like worn by the worker.

In this case, the determination unit 13 treats the detected motion as one element in the determination. In addition, the determination unit 13 treats a positional relationship between the person who performs this motion and the specified predetermined object as one element in the determination. For example, when the position of the object does not correspond to the predetermined position of the person related to the predetermined motion, the determination unit 13 determines that this is not safe. More specifically, for example, the determination unit 13 determines that the person P10 is safe when it is detected that the person P10 performing predetermined construction work at the work site wears a helmet on the head. On the other hand, the determination unit 13 determines that the person P10 is not safe (that is, in danger) when it is not detected that the person P10 performing predetermined construction work at the work site wears the helmet on the head.

The related image specifying unit 12 specifies an object having a predetermined dangerous area as a related image. Examples of the object having a predetermined dangerous area include heavy machines such as a truck, a crane vehicle, and a wheel loader, and equipment such as a cutting machine, a concrete mixer, and a high voltage power supply. Predetermined dangerous areas may be set for these objects. For example, entry of a person other than a person for a predetermined work into the dangerous area is prohibited.

In this case, when there is a person related to a motion different from a predetermined motion permitted in the dangerous area, the determination unit 13 determines that the person is not safe. More specifically, for example, when there is a person who is performing construction work unrelated to the heavy machine in a dangerous area around the heavy machine, the determination unit 13 determines that the person P10 is not safe.

The related image specifying unit 12 may specify a predetermined determination area as a related image. The predetermined area is, for example, an area where a safety check motion is performed. In this case, the determination unit 13 determines whether or not the person is safe based on the positional relationship between the person related to the motion and the determination area. More specifically, for example, when the worker P10 performs a prescribed check motion in the determination area where the safety check motion is required, the determination unit 13 determines that the worker P10 is safe. On the other hand, when the worker P10 does not perform the prescribed check motion in the determination area, the determination unit 13 determines that the worker P10 is not safe.

The determination unit 13 according to the present example embodiment performs determination regarding safety with reference to predetermined safety standard data. The determination unit 13 reads a safety standard database included in the storage unit 210. The safety standard database includes a plurality of pieces of safety standard data. The safety standard data is data used when it is determined whether or not a person is safe, and includes data related to the motion of the person, data related to the related image, and data related to the positional relationship between the person and the related image. The output unit 14 according to the present example embodiment outputs the determination information generated by the determination unit 13 to the display unit 202.

The image data acquisition unit 201 is an interface that acquires image data supplied from the camera 100. The image data acquired by the image data acquisition unit 201 includes images captured by the camera 100 every predetermined period. The image data acquisition unit 201 supplies the acquired image data to the motion detection unit 11 and the related image specifying unit 12.

The display unit 202 is a display including a liquid crystal panel or organic electroluminescence. The display unit 202 displays the determination information output from the output unit 14, and presents a result of the determination to the user of the management apparatus 20.

The operation receiving unit 203 includes, for example, an information input means such as a keyboard and a touch pad, and receives an operation from the user who operates the management apparatus 20. The operation receiving unit 203 may be a touch panel superimposed on the display unit 202 and set to interlock with the display unit 202.

The storage unit 210 is a storage means including a non-volatile memory, such as a flash memory. The storage unit 210 stores at least a registered motion database and a safety standard database. The registered motion database includes skeleton data as a registered motion. The safety standard database includes a plurality of pieces of safety standard data. That is, the storage unit 210 stores at least the safety standard data related to the positional relationship between the person related to the motion and the related image.

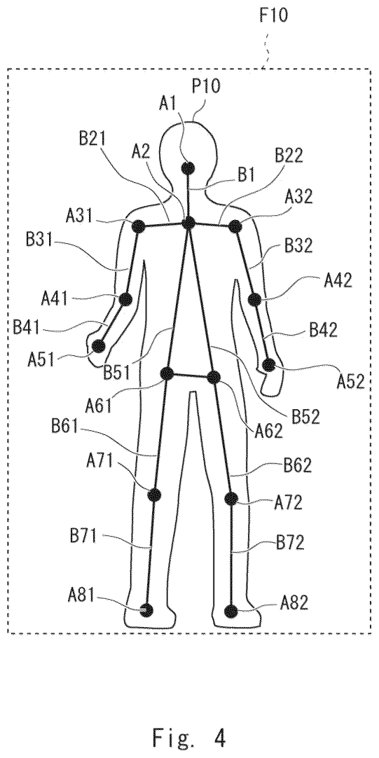

Next, an example of detecting the posture of a person will be described with reference to FIG. 4. FIG. 4 is a diagram illustrating skeleton data extracted from image data. The image illustrated in FIG. 4 is a body image F10 obtained by extracting the body of the person P10 from the image captured by the camera 100. In the management apparatus 20, the motion detection unit 11 cuts out the body image F10 from the image captured by the camera 100, and sets the skeleton structure.

The motion detection unit 11 extracts, for example, feature points that can be key points of the person P10 from the image. In addition, the motion detection unit 11 detects key points from the extracted feature points. When detecting key points, the motion detection unit 11 refers to, for example, information machine-learned about the image of key points.

In the example illustrated in FIG. 4, the motion detection unit 11 detects a head A1, a neck A2, a right shoulder A31, a left shoulder A32, a right elbow A41, a left elbow A42, a right hand A51, a left hand A52, a right waist A61, a left waist A62, a right knee A71, a left knee A72, a right foot A81, and a left foot A82 as key points of the person P10.

In addition, the motion detection unit 11 sets bones connecting these key points as a pseudo skeleton structure of the person P10 as follows. The bone B1 connects the head A1 and the neck A2 to each other. The bone B21 connects the neck A2 and the right shoulder A31 to each other, and the bone B22 connects the neck A2 and the left shoulder A32 to each other. The bone B31 connects the right shoulder A31 and the right elbow A41 to each other, and the bone B32 connects the left shoulder A32 and the left elbow A42 to each other. The bone B41 connects the right elbow A41 and the right hand A51 to each other, and the bone B42 connects the left elbow A42 and the left hand A52 to each other. The bone B51 connects the neck A2 and the right waist A61 to each other, and the bone B52 connects the neck A2 and the left waist A62 to each other. The bone B61 connects the right waist A61 and the right knee A71 to each other, and the bone B62 connects the left waist A62 and the left knee A72 to each other. Then, the bone B71 connects the right knee A71 and the right foot A81 to each other, and the bone B72 connects the left knee A72 and the left foot A82 to each other. When the skeleton data related to the skeleton structure is generated, the motion detection unit 11 compares the generated skeleton data with the registered motion.

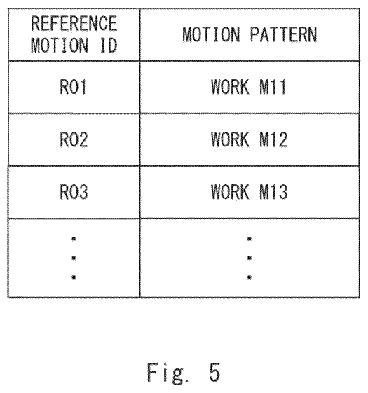

Next, an example of the registered motion database will be described with reference to FIG. 5. FIG. 5 is a diagram for explaining a registered motion database according to the second example embodiment. In the table illustrated in FIG. 5, a registered motion ID (identification, identifier) and a plurality of motion patterns are associated with each other. A motion pattern related to a motion whose registered motion ID (or motion ID) is “R01” is “work M11”. Similarly, a motion pattern whose registered motion ID is “R02” is “work M12”, and a motion pattern whose registered motion ID is “R03” is “work M13”. In addition to the predetermined work, the registered motion database may have a motion pattern in a crouching state or a falling-down state as a motion pattern for detecting a dangerous situation.

As described above, the data regarding the registered motion included in the registered motion database is stored so that the motion ID and the motion pattern are associated with each other for each motion. Each motion pattern is associated with one or more pieces of skeleton data. For example, the registered motion whose motion ID is “R01” includes skeleton data indicating a motion of performing predetermined construction work.

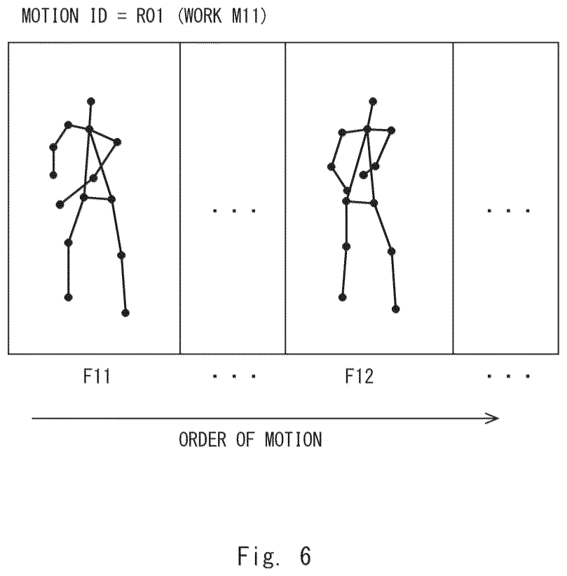

The skeleton data according to the registered motion will be described with reference to FIG. 6. FIG. 6 is a diagram for explaining a first example of the registered motion according to the second example embodiment. FIG. 6 illustrates skeleton data regarding a motion having a motion ID “R01” among the registered motions included in the registered motion database. FIG. 6 illustrates a plurality of pieces of skeleton data including skeleton data F11 and skeleton data F12 in a state of being arranged in the left-right direction. The skeleton data F11 is located on the left side of the skeleton data F12. The skeleton data F11 is a posture obtained by capturing a scene of a person performing a series of construction work. The skeleton data F12 is a scene of a person who is performing a series of construction work, and has a posture different from that of the skeleton data F11.

FIG. 6 means that, in the registered motion having a motion ID “R01”, the person takes a posture corresponding to the skeleton data F11 and then takes a posture of the skeleton data F12. In addition, although two pieces of skeleton data have been described herein, the registered motion having a motion ID “R01” may include skeleton data other than the above-described skeleton data.

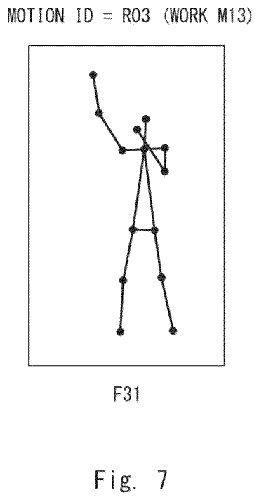

FIG. 7 is a diagram for explaining a second example of the registered motion according to the second example embodiment. FIG. 7 illustrates skeleton data F31 related to the motion having a motion ID “R03” illustrated in FIG. 5. In the registered motion having a motion ID “R03”, only one piece of skeleton data F31 indicating a person performing a guiding motion at the work site is registered.

As described above, the registered motion included in the registered motion database may include only one piece of skeleton data or may include two or more pieces of skeleton data. The motion detection unit 11 determines whether or not there is a similar registered motion by comparing the registered motion including the above-described skeleton data with the skeleton data estimated from the image received from the image data acquisition unit 201.

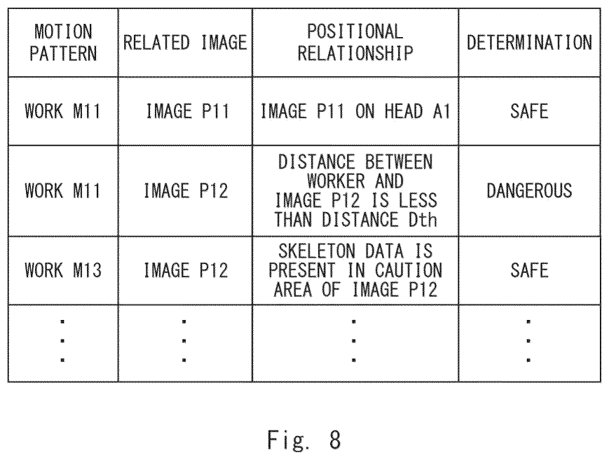

Next, a safety standard database will be described with reference to FIG. 8. FIG. 8 is a diagram for explaining a safety standard database according to the second example embodiment. The table illustrated in FIG. 8 illustrates the safety standard database, and “motion pattern”, “related image”, “positional relationship”, and “determination” are arranged in the left-right direction so as to correspond to each other.

For example, in the upper row of the table, “work M11” is illustrated as a motion pattern, and in the same row, “image P11” as a related image, “image P11 on head A1” as a positional relationship, and “safe” as determination are illustrated. In this example, the image P11 means a helmet. That is, the safety standard data illustrated herein is a content indicating that the person is “safe” when the helmet (image P11) corresponds to the head (A1) of the person while the person is performing a predetermined construction work (work M11).

Similarly, in the second row of the table illustrated in FIG. 8, “work M11” as a motion pattern, “image P12” as a related image, “distance between worker and image P12 is less than distance Dth” as a positional relationship, and “danger” as a determination are illustrated. In this example, the image P12 means a truck. That is, the safety standard data illustrated herein is a content indicating “danger” when the distance between the person and the truck (image P12) is less than the distance Dth that is a threshold value while the person is performing predetermined construction work (work M11).

Similarly, in the third row of the table illustrated in FIG. 8, “work M13” as a motion pattern, “image P12” as a related image, “skeleton data is present in caution area of image P12” as a positional relationship, and “safe” as determination are illustrated. In addition, in the case of this example, it is assumed that a caution area corresponding to the image P12 is set. The safety standard data illustrated herein is a content indicating that the person is “safe” when the person (skeleton data) is present in the caution area of the truck (image P12) while the person is performing a predetermined guiding motion (work M13).

Up to now, the safety standard database has been described. The determination unit 13 of the management apparatus 20 determines whether or not a person is safe by referring to the safety standard as described above.

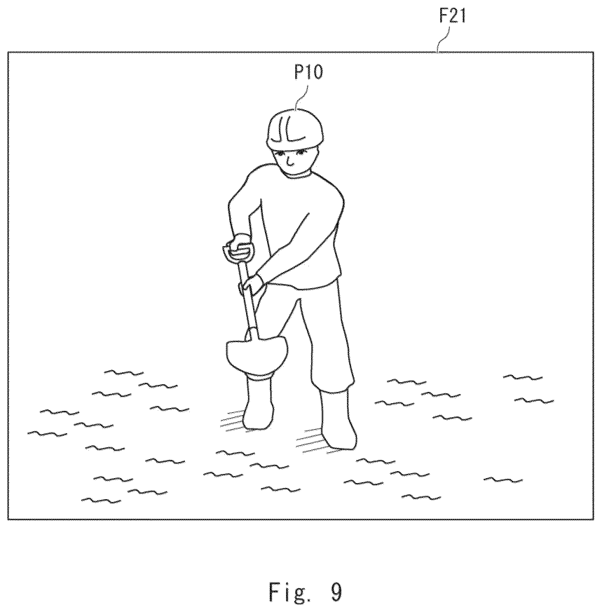

Next, the safety standard data will be described while describing a specific image example. FIG. 9 is a diagram illustrating a first example of an image captured by a camera. An image F21 illustrated in FIG. 8 is an image captured by the camera 100 and includes the worker P10. The worker P10 performs predetermined construction work at the work site. The management apparatus 20 receives image data of this image, and determines whether or not the worker P10 is safe.

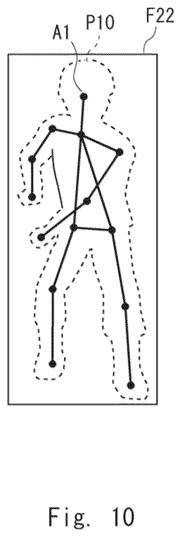

FIG. 10 is a diagram illustrating skeleton data extracted by the management apparatus. An image F22 illustrated in FIG. 10 is a body image of the person P10 extracted by the motion detection unit 11 and skeleton data generated by being estimated from the body image. The skeleton data includes the head A1. The motion detection unit 11 compares the skeleton data with the registered motion database. Here, the skeleton data illustrated in FIG. 10 corresponds to the work M11 of the motion pattern R01. In addition, it is assumed that the motion detection unit 11 acquires the skeleton data of the motion corresponding to the work M11 at different times after the image illustrated in FIG. 10. Therefore, the motion detection unit 11 determines that the person P10 is performing the work M11.

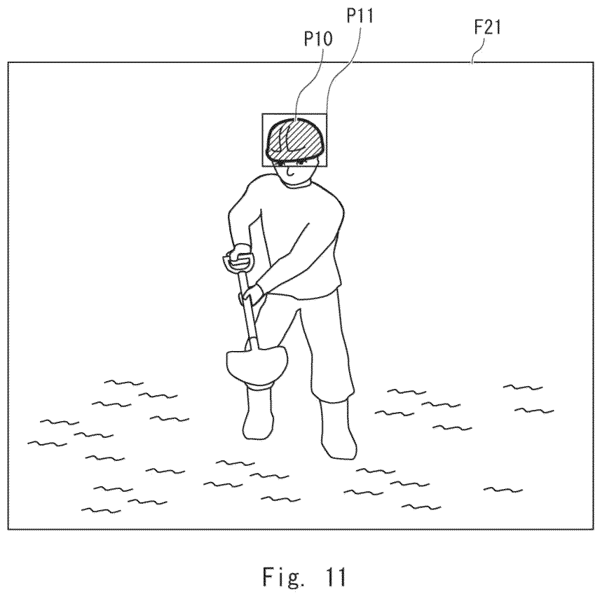

FIG. 11 is a diagram illustrating a related image specified by the management apparatus. FIG. 11 illustrates a state in which an image P11 of the helmet worn by the person P10 is detected in the image F21. For example, the related image specifying unit 12 can search for related images and detect the related image P11 by performing predetermined convolution processing on the image F21 together with a known method such as histogram of oriented gradients (HOG) or machine learning.

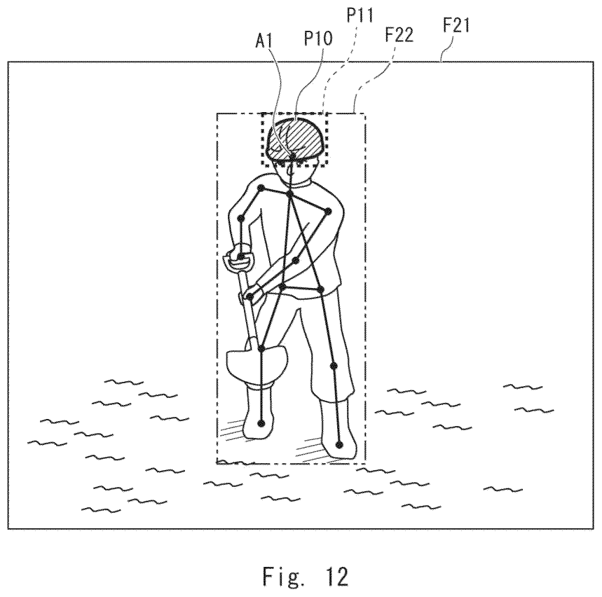

FIG. 12 is a diagram in which skeleton data and a related image are superimposed on an image captured by a camera. The determination unit 13 of the management apparatus 20 refers to each of the skeleton data illustrated in FIG. 10 and the related image illustrated in FIG. 11 and recognizes a positional relationship therebetween. As illustrated in FIG. 12, the person P10 performing a motion corresponding to the work M11 with a registered motion ID R01 has a related image P11 (helmet) on the head A1. Therefore, the determination unit 13 determines that the person P10 included in the image F21 is safe.

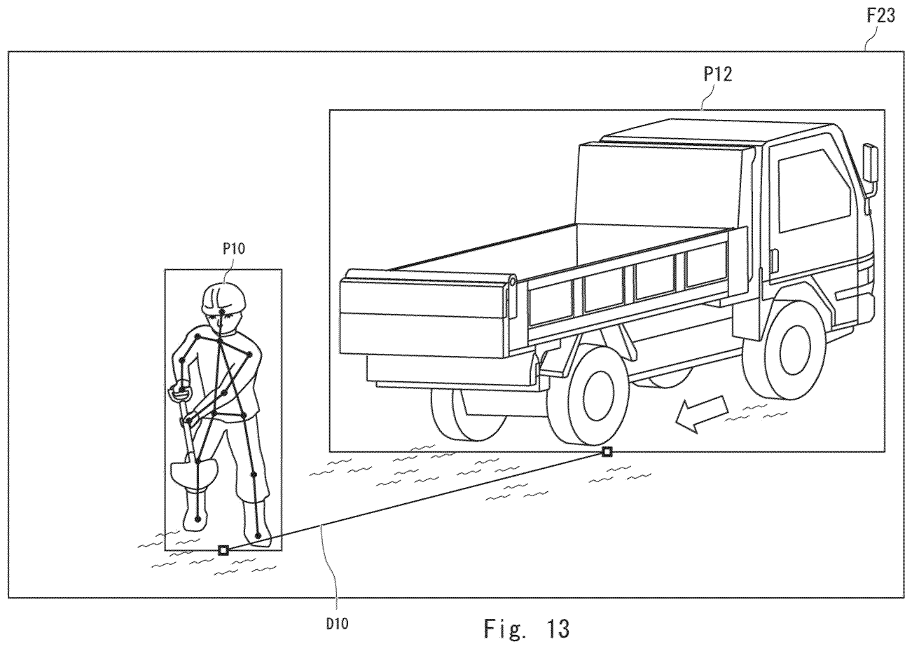

Next, another example of the safety standard data will be described with reference to FIG. 13. FIG. 13 is a diagram illustrating a second example of the image captured by the camera. An image F23 illustrated in FIG. 13 is an image captured by the camera 100, and includes a person P10 performing a work M11, which is a predetermined construction work, and a related image P12 of a truck approaching the person P10. The image illustrated herein corresponds to the safety standard data illustrated in the second row of FIG. 8.

In the image F23 illustrated in FIG. 13, the motion detection unit 11 detects that the person P10 is performing the work M11 of the motion pattern R01. In addition, the related image specifying unit 12 detects the related image P12 that is a truck. In addition, the determination unit 13 calculates a distance D10 between the person P10 and the related image P12. In this example, the determination unit 13 calculates the distance between the person P10 and the truck from the straight line connecting a point at the lower center of the image of the specified person and a point at the lower center of the image of the truck to each other. At this time, the determination unit 13 is set to be able to calculate the distance between any two points from the angle of view or the imaging angle of the camera. Therefore, the determination unit 13 can determine whether or not the distance D10 is less than the predetermined threshold value Dth. Therefore, the determination unit 13 determines “danger” when the distance D10 is less than the threshold value Dth in the image F23, and does not determine “danger” when the distance D10 is equal to or greater than the threshold value Dth.

In this manner, the management apparatus 20 determines whether or not the person is safe by referring to the motion of the person and the positional relationship between the person and the related image. As a result, the management apparatus 20 can appropriately determine a safe situation according to the work content of the person.

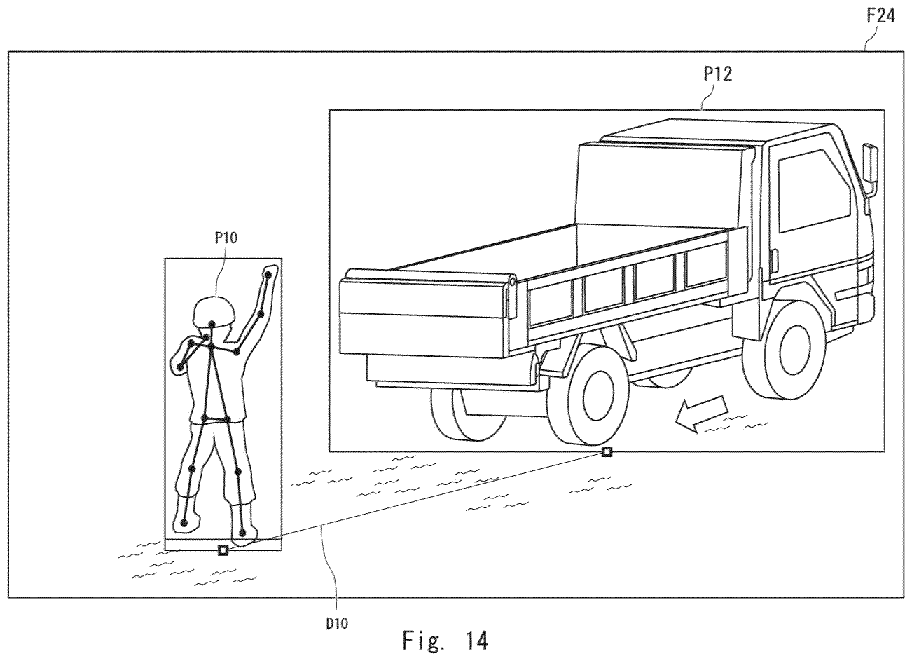

The safety standard data will be further described with reference to FIG. 14. FIG. 14 is a diagram illustrating a third example of the image captured by the camera. An image F24 illustrated in FIG. 14 is different from that in FIG. 13 in the motion of the person P10. The person P10 included in the image F24 performs a work M13 that is a motion of guiding a truck.

In the image F24 illustrated in FIG. 14, the motion detection unit 11 detects that the person P10 is performing the work M13 of the motion pattern R03. In addition, the related image specifying unit 12 detects the related image P12 that is a truck. In addition, the determination unit 13 calculates a distance D10 between the person P10 and the related image P12. Since the motion of the person P10 in the image F24 is not the work M11, the determination unit 13 does not determine that the person P10 is “in danger”.

As described above, by referring to the motion of the person and the positional relationship between the person and the related image, the management apparatus 20 may not determine that the person is in danger according to the motion performed by the person even if the person and an object related to the related image are present nearby. As a result, the management apparatus 20 can appropriately determine the dangerous situation according to the work content of the person.

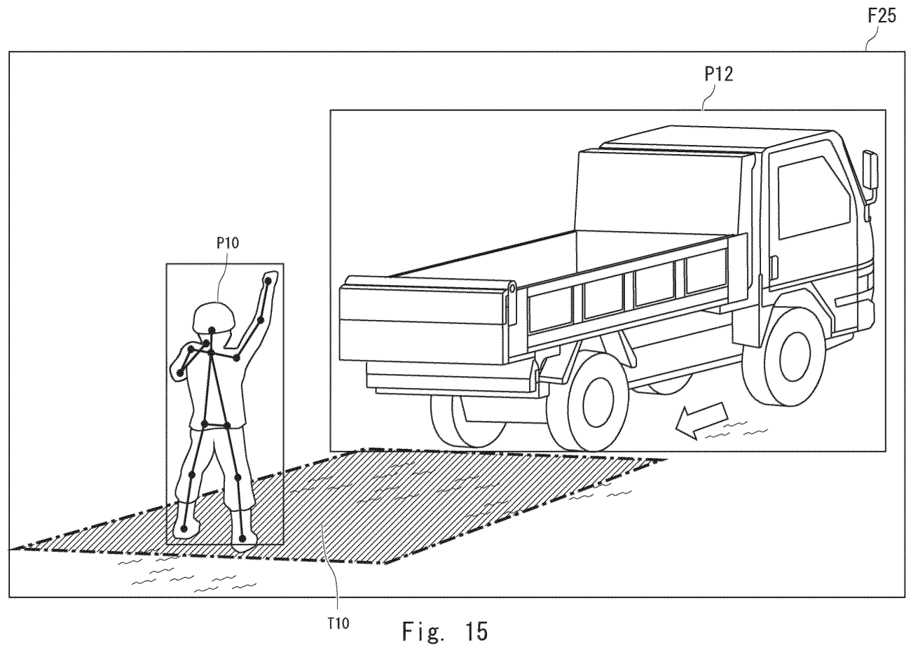

FIG. 15 is a diagram illustrating a fourth example of the image captured by the camera. An image F25 illustrated in FIG. 15 is an example of the safety standard data illustrated in the third row of the table illustrated in FIG. 8. In the example illustrated in the image F24, a caution area corresponding to the related image P12 is set.

In the image F25 illustrated in FIG. 15, the motion detection unit 11 detects that the person P10 is performing the work M13 of the motion pattern R03. In addition, the related image specifying unit 12 detects the related image P12 that is a truck. In addition, the determination unit 13 refers to the positional relationship between the person P10 and a caution area T10 associated with the related image P12. The person P10 present in the caution area T10 is performing the work M13 as a motion pattern. The safety standard database indicates that the person is “safe” when the person (skeleton data) is present in the caution area of the truck (image P12) while the person is performing a predetermined guiding motion (work M13). Therefore, the determination unit 13 determines that the person P10 is “safe”.

As described above, the management apparatus 20 can determine that only a person who performs a motion set in advance in a predetermined area is safe. Conversely, the management apparatus 20 does not determine that a person who performs a motion other than the motion set in advance in the predetermined area is safe. That is, the management apparatus 20 can determine that such a person is in danger. With such a configuration, the management apparatus 20 can appropriately determine the safe or dangerous situation of the person according to the work content of the person and the positional relationship with the related image.

Although the configuration of the second example embodiment has been described above, the management system 2 according to the second example embodiment is not limited to the above-described configuration. For example, the number of cameras 100 included in the management system 2 is not limited to one, and may be plural. The camera 100 may have some functions of the motion detection unit 11. In this case, for example, the camera 100 may extract the body image related to the person by processing the captured image. Alternatively, the camera 100 may further extract skeleton data of at least a part of the body of the person from the body image based on the characteristics of joints and the like of the person recognized in the body image.

The management apparatus 20 and the camera 100 may directly communicate with each other without the network N1. The management apparatus 20 may include the camera 100. That is, the management system 2 may have the same meaning as the management apparatus 20.

The motion detection unit 11 may detect motions of a plurality of persons from image data of an image obtained by capturing a place including a plurality of persons. In this case, the determination unit 13 determines whether or not each person is safe based on the positional relationships between each of a plurality of persons and the related image.

With the configuration described above, according to the second example embodiment, it is possible to provide a management apparatus and the like that can efficiently and easily manage the safety of the worker.

### Third Example Embodiment

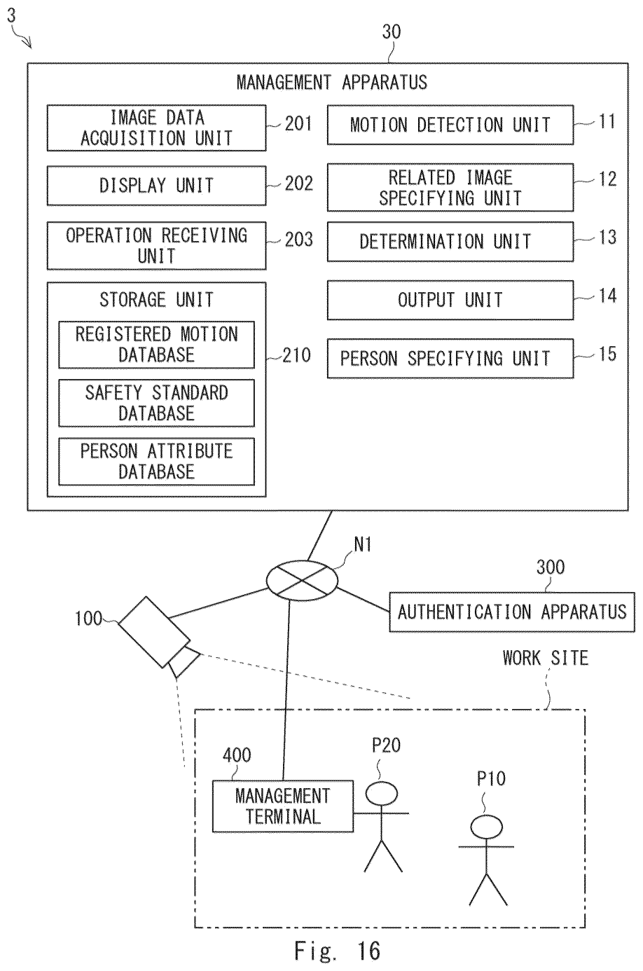

Next, a third example embodiment will be described with reference to FIG. 16. FIG. 16 is a diagram illustrating the overall configuration of a management system 3 according to the third example embodiment. The management system 3 illustrated in FIG. 16 includes a management apparatus 30, a camera 100, an authentication apparatus 300, and a management terminal 400. These components are communicably connected to each other through the network N1. That is, the management system 3 according to the present example embodiment is different from that in the second example embodiment in that the management apparatus 30 is provided instead of the management apparatus 20 and the authentication apparatus 300 and the management terminal 400 are provided.

The management apparatus 30 specifies a predetermined person in cooperation with the authentication apparatus 300, determines whether or not the specified person is safe, and outputs a determination result to the management terminal 400. The management apparatus 30 is different from the management apparatus 20 according to the second example embodiment in that the management apparatus 30 includes a person specifying unit 15. In addition, the storage unit 210 included in the management apparatus 30 is different from that in the management apparatus 20 according to the second example embodiment in that a person attribute database related to a specified person is stored.

The person specifying unit 15 specifies a person included in the image data. The person specifying unit 15 specifies a person included in the image captured by the camera 100 by associating the authentication data of the person authenticated by the authentication apparatus 300 with the attribute data stored in the person attribute database.

In this case, the output unit 14 outputs whether or not the specified person is safe to the management terminal 400. Then, when the specified person is not safe, a warning signal corresponding to the specified person is output to the management terminal 400. That is, the output unit 14 according to the present example embodiment outputs a predetermined warning signal when it is determined that the person is not safe.

In addition, the determination unit 13 may have a plurality of safety levels for determining whether or not the person is safe. In this case, the output unit 14 outputs a warning signal corresponding to the safety level. With such a configuration, the management apparatus 30 can perform management related to safety more flexibly.

The person attribute database stored in the storage unit 210 includes attribute data of the specified person. The attribute data includes a name of a person, a unique identifier, and the like. The attribute data may include data related to the work of the person. That is, the attribute data can include, for example, a group to which the person belongs, a type of work performed by the person, and the like. In addition, the attribute data may have, for example, a blood type, age, gender, or the like of a person as data related to safety.

The motion detection unit 11, the related image specifying unit 12, and the determination unit 13 according to the present example embodiment may perform determination according to the attribute data of the person. That is, for example, the motion detection unit 11 may compare the registered motion corresponding to the specified person. The related image specifying unit 12 may recognize a related image corresponding to the specified person. In addition, the determination unit 13 may perform the determination by referring to the safety standard data corresponding to the specified person. With such a configuration, the management apparatus 30 can perform determination customized to the specified person.

The authentication apparatus 300 is a computer or a server apparatus including one or a plurality of arithmetic apparatuses. The authentication apparatus 300 authenticates a person present at the work site from the image captured by the camera 100, and supplies a result of the authentication to the management apparatus 30. When the authentication of the person is successful, the authentication apparatus 300 supplies authentication data associated with the person attribute data stored in the management apparatus 30 to the management apparatus 30.

The management terminal 400 is a tablet terminal, a smartphone, a dedicated terminal apparatus having a display device, or the like, and can receive determination information generated by the management apparatus 30 and present the received determination information to a manager P20. By recognizing the determination information presented to the management terminal 400 at the work site, the manager P20 can know whether or not the person P10 who is a worker is safe.

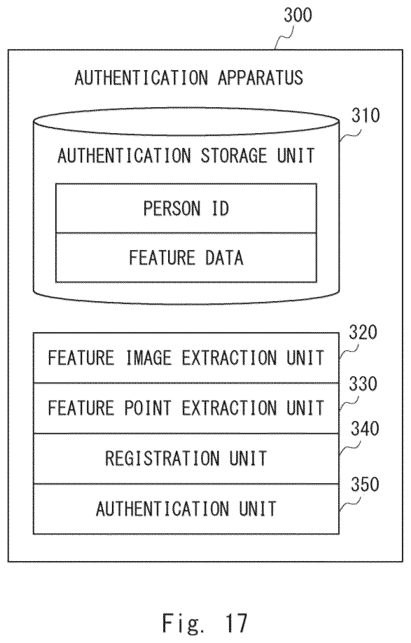

Next, the configuration of the authentication apparatus 300 will be described in detail with reference to FIG. 17. FIG. 17 is a block diagram of the authentication apparatus 300. The authentication apparatus 300 authenticates a person by extracting a predetermined feature image from the image captured by the camera 100. The feature image is, for example, a facial image. The authentication apparatus 300 includes an authentication storage unit 310, a feature image extraction unit 320, a feature point extraction unit 330, a registration unit 340, and an authentication unit 350.

The authentication storage unit 310 stores a person ID and feature data of the person in association with each other. The feature image extraction unit 320 detects a feature area included in the image acquired from the camera 100 and outputs the feature area to the feature point extraction unit 330. The feature point extraction unit 330 extracts a feature point from the feature area detected by the feature image extraction unit 320, and outputs data regarding the feature point to the registration unit 340. The face feature information is a set of extracted feature points.

The registration unit 340 newly issues a person ID when registering the feature data. The registration unit 340 registers the issued person ID and the feature data extracted from the registered image in the authentication storage unit 310 in association with each other. The authentication unit 350 compares the feature data extracted from the feature image with the feature data in the authentication storage unit 310. The authentication unit 350 determines that the authentication is successful when the pieces of feature data match each other, and determines that the authentication has failed when the pieces of feature data do not match each other. The authentication unit 350 notifies the management apparatus 30 of success or failure of the authentication. When the authentication is successful, the authentication unit 350 specifies the person ID associated with the successful feature data and notifies the management apparatus 30 of the authentication result including the specified person ID.

In addition, the authentication apparatus 300 may perform authentication of a person using a means different from the camera 100. The authentication may be biometric authentication or authentication using a mobile terminal, an IC card, or the like.

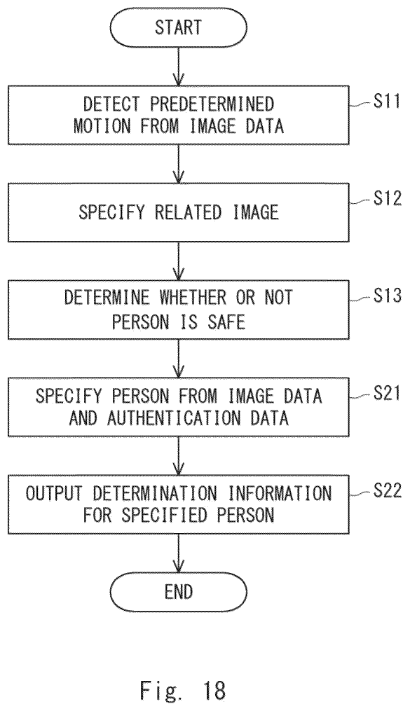

Processing performed by the management apparatus 30 according to the present example embodiment will be described with reference to FIG. 18. FIG. 18 is a flowchart illustrating a management method according to the third example embodiment. The flowchart illustrated in FIG. 18 is different from the flowchart illustrated in FIG. 2 in processing after step S13.

After step S13, the person specifying unit 15 specifies a person related to the determination information from the image data and the authentication data (step S21). Then, the output unit 14 outputs determination information for the specified person to the management terminal 400 (step S22). When the determination information is output to the management terminal 400, the management apparatus 30 ends a series of processes.

In addition, the method executed by the management apparatus 30 is not limited to the method illustrated in FIG. 18. The management apparatus 30 may execute step S21 before step S13. In addition, the processing from step S11 to step S13 may correspond to the person specified as described above.

With the configuration described above, according to the third example embodiment, it is possible to provide a management apparatus and the like that can efficiently and easily manage the safety of the worker.

### Example of Hardware Configuration

Hereinafter, a case where each functional component of the determination apparatus in the present disclosure is implemented by a combination of hardware and software will be described.

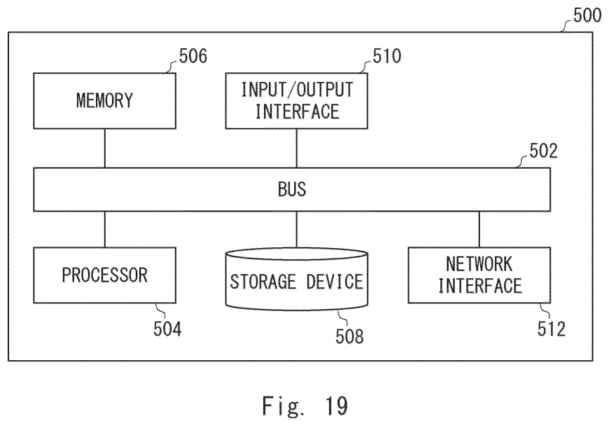

FIG. 19 is a block diagram illustrating the hardware configuration of a computer. A management apparatus in the present disclosure can implement the above-described functions using a computer 500 having the hardware configuration illustrated in the diagram. The computer 500 may be a portable computer such as a smartphone or a tablet terminal, or may be a stationary computer such as a PC. The computer 500 may be a dedicated computer designed to implement each apparatus, or may be a general-purpose computer. The computer 500 can implement a desired function by installing a predetermined program.

The computer 500 includes a bus 502, a processor 504, a memory 506, a storage device 508, an input/output interface 510 (an interface is also referred to as an I/F (interface)), and a network interface 512. The bus 502 is a data transmission path for the processor 504, the memory 506, the storage device 508, the input/output interface 510, and the network interface 512 to transmit and receive data to and from each other. However, a method of connecting the processor 504 and the like to each other is not limited to the bus connection.

The processor 504 is various processors such as a CPU, a GPU, or an FPGA. The memory 506 is a main storage device implemented by using a random access memory (RAM) or the like.

The storage device 508 is an auxiliary storage device implemented by using a hard disk, an SSD, a memory card, a read only memory (ROM), or the like. The storage device 508 stores a program for implementing a desired function. The processor 504 reads the program to the memory 506 and executes the program to implement each functional component of each apparatus.

The input/output interface 510 is an interface for connecting the computer 500 and an input/output apparatus to each other. For example, an input apparatus such as a keyboard and an output apparatus such as a display device are connected to the input/output interface 510.

The network interface 512 is an interface for connecting the computer 500 to a network.

Although the example of the hardware configuration in the present disclosure has been described above, the above-described example embodiment is not limited thereto. The present disclosure can also be implemented by causing a processor to execute a computer program.

In the above-described example, the program includes a group of instructions (or software code) for causing a computer to perform one or more functions described in the example embodiments when being read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. As an example and not by way of limitation, transitory computer-readable or communication media include electrical, optical, acoustic, or other forms of propagated signals.

Although the invention of the present application has been described above with reference to the example embodiments, the invention of the present application is not limited to the above. Various modifications that can be understood by those skilled in the art can be made to the configuration and details of the invention of the present application within the scope of the invention.

Some or all of the above example embodiments may be described as the following supplementary notes, but are not limited to the following.

### Supplementary Note 1

A management apparatus including:
a motion detection means for detecting a predetermined motion performed by a person from an image obtained by capturing a predetermined place including the person;
a related image specifying means for specifying a related image showing a predetermined object or area related to safety of the person from the image obtained by capturing the predetermined place;
a determination means for determining whether or not the person is in a safe situation based on the detected motion and a positional relationship between the person performing the motion and the object or the area indicated by the related image; and
an output means for outputting determination information including a result of the determination performed by the determination means.

### Supplementary Note 2

The management apparatus according to Supplementary Note 1, wherein the motion detection means detects the motion similar to a predetermined registered motion.

### Supplementary Note 3

The management apparatus according to Supplementary Note 2, wherein the motion detection means detects the motion from skeleton data regarding a structure of a body of the person extracted from an image including the person.

### Supplementary Note 4

The management apparatus according to Supplementary Note 3, wherein the motion detection means detects the motion by comparing the skeleton data related to the motion with the skeleton data as the registered motion based on a form of each element forming the skeleton data.

### Supplementary Note 5

The management apparatus according to any one of Supplementary Notes 1 to 4, wherein
the motion detection means detects a type of the motion based on the registered motion, and
the determination means determines whether or not the person is in a safe situation based on the type of the motion and a positional relationship between the person and the object or the area indicated by the related image.

### Supplementary Note 6

The management apparatus according to any one of Supplementary Notes 1 to 5, wherein the motion detection means detects the motion from a posture change extracted in time series from each of a plurality of images captured at a plurality of different times.

### Supplementary Note 7

The management apparatus according to any one of Supplementary Notes 1 to 6, further including: a storage means for storing safety standard data related to a positional relationship between the person related to the motion and the related image,
wherein the determination means determines whether or not the person is safe with reference to the safety standard data.

### Supplementary Note 8

The management apparatus according to any one of Supplementary Notes 1 to 7, wherein
the related image specifying means specifies a predetermined object worn on a body of the person as the related image, and
the determination means determines that the person is not safe when a position of the object does not correspond to a predetermined position of the person related to the predetermined motion.

### Supplementary Note 9

The management apparatus according to any one of Supplementary Notes 1 to 7, wherein
the related image specifying means specifies an object having a predetermined dangerous area as the related image, and
the determination means determines that the person is not safe when there is the person related to a motion different from the predetermined motion permitted in the dangerous area.

### Supplementary Note 10

The management apparatus according to any one of Supplementary Notes 1 to 7, wherein
the related image specifying means specifies a predetermined determination area as the related image, and
the determination means determines whether or not the person is safe based on a positional relationship between the person related to the motion and the determination area.

### Supplementary Note 11

The management apparatus according to any one of Supplementary Notes 1 to 10, wherein
the motion detection means detects the motion of each of a plurality of the persons from an image obtained by capturing the place including the plurality of persons, and
the determination means determines whether or not the person is safe based on the positional relationship between each of the plurality of persons and the related image.

### Supplementary Note 12

The management apparatus according to any one of Supplementary Notes 1 to 11, wherein the output means outputs a predetermined warning signal when it is determined that the person is not safe.

### Supplementary Note 13

The management apparatus according to Supplementary Note 12, wherein
the determination means has a plurality of safety levels for determining whether or not the person is safe, and
the output means outputs the warning signal corresponding to the safety level.

### Supplementary Note 14

The management apparatus according to Supplementary Note 12 or 13, further including: a person specifying means for specifying the person included in an image,
wherein the output means outputs the warning signal corresponding to the specified person when the specified person is not safe.

### Supplementary Note 15

A management method
causing a computer to execute:
detecting a predetermined motion performed by a person from an image obtained by capturing a predetermined place including the person;
specifying a predetermined related image related to safety of the person;
determining whether or not the person is in a safe situation based on the detected motion and a positional relationship between the person performing the motion and the related image; and
outputting determination information including a result of the determination.

### Supplementary Note 16

A non-transitory computer-readable medium storing a program for causing a computer to execute a management method including:
detecting a predetermined motion performed by a person from an image obtained by capturing a predetermined place including the person;
specifying a predetermined related image related to safety of the person;
determining whether or not the person is in a safe situation based on the detected motion and a positional relationship between the person performing the motion and the related image; and
outputting determination information including a result of the determination.

### REFERENCE SIGNS LIST

2 MANAGEMENT SYSTEM
3 MANAGEMENT SYSTEM
10 MANAGEMENT APPARATUS
11 MOTION DETECTION UNIT
12 RELATED IMAGE SPECIFYING UNIT
13 DETERMINATION UNIT
14 OUTPUT UNIT
15 PERSON SPECIFYING UNIT
100 CAMERA
20 MANAGEMENT APPARATUS
30 MANAGEMENT APPARATUS
201 IMAGE DATA ACQUISITION UNIT
202 DISPLAY UNIT
203 OPERATION RECEIVING UNIT
210 STORAGE UNIT
300 AUTHENTICATION APPARATUS
310 AUTHENTICATION STORAGE UNIT
320 FEATURE IMAGE EXTRACTION UNIT
330 FEATURE POINT EXTRACTION UNIT
340 REGISTRATION UNIT
350 AUTHENTICATION UNIT
400 MANAGEMENT TERMINAL
500 COMPUTER
504 PROCESSOR
506 MEMORY
508 STORAGE DEVICE
510 INPUT/OUTPUT INTERFACE
512 NETWORK INTERFACE
N1 NETWORK

What is claimed is:

1. A management apparatus comprising:
a memory configured to store instructions; and
a processor configured to execute the instructions to:
detect a predetermined motion performed by a person from an image obtained by capturing a predetermined place including the person;
specify a related image showing a predetermined object or area related to safety of the person from the image obtained by capturing the predetermined place;
determine whether or not the person is in a safe situation based on the detected motion and a positional relationship between the person performing the motion and the object or the area indicated by the related image; and
output determination information including a result of the determination performed.

2. The management apparatus according to claim 1, wherein the processor is configured to execute the instructions to detect the motion similar to a predetermined registered motion.

3. The management apparatus according to claim 2, wherein the processor is configured to execute the instructions to detect the motion from skeleton data regarding a structure of a body of the person extracted from an image including the person.

4. The management apparatus according to claim 3, wherein the processor is configured to execute the instructions to detect the motion by comparing the skeleton data related to the motion with the skeleton data as the registered motion based on a form of each element forming the skeleton data.

5. The management apparatus according to claim 2, wherein
the processor is configured to execute the instructions to:
detect a type of the motion based on the registered motion; and
determine whether or not the person is in a safe situation based on the type of the motion and a positional relationship between the person and the object or the area indicated by the related image.

6. The management apparatus according to claim 1, wherein the processor is configured to execute the instructions to detect the motion from a posture change extracted in time series from each of a plurality of images captured at a plurality of different times.

7. The management apparatus according to claim 1, the memory is configured to store safety standard data related to a positional relationship between the person related to the motion and the related image,
wherein the processor is configured to execute the instructions to determine whether or not the person is safe with reference to the safety standard data.

8. The management apparatus according to claim 1, wherein the processor is configured to execute the instructions to:
specify a predetermined object worn on a body of the person as the related image; and
determine that the person is not safe when a position of the object does not correspond to a predetermined position of the person related to the predetermined motion.

9. The management apparatus according to claim 1, wherein the processor is configured to execute the instructions to:
specify an object having a predetermined dangerous area as the related image; and
determine that the person is not safe when there is the person related to a motion different from the predetermined motion permitted in the dangerous area.

10. The management apparatus according to claim 1, wherein the processor is configured to execute the instructions to:
specify a predetermined determination area as the related image; and
determine whether or not the person is safe based on a positional relationship between the person related to the motion and the determination area.

11. The management apparatus according to claim 1, wherein the processor is configured to execute the instructions to:
detect the motion of each of a plurality of the persons from an image obtained by capturing the place including the plurality of persons; and
determine whether or not the person is safe based on the positional relationship between each of the plurality of persons and the related image.

12. The management apparatus according to claim 1, wherein the processor is configured to execute the instructions to output a predetermined warning signal when it is determined that the person is not safe.

13. The management apparatus according to claim 12, wherein
the apparatus has a plurality of safety levels for determining whether or not the person is safe, and
the processor is configured to execute the instructions to output the warning signal corresponding to the safety level.

14. The management apparatus according to claim 12, the processor is configured to execute the instructions to:
specify the person included in an image; and
output the warning signal corresponding to the specified person when the specified person is not safe.

15. A management method
causing a computer to execute:
detecting a predetermined motion performed by a person from an image obtained by capturing a predetermined place including the person;
specifying a predetermined related image related to safety of the person;
determining whether or not the person is in a safe situation based on the detected motion and a positional relationship between the person performing the motion and the related image; and
outputting determination information including a result of the determination.

16. A non-transitory computer-readable medium storing a program for causing a computer to execute a management method including:
detecting a predetermined motion performed by a person from an image obtained by capturing a predetermined place including the person;
specifying a predetermined related image related to safety of the person;
determining whether or not the person is in a safe situation based on the detected motion and a positional relationship between the person performing the motion and the related image; and
outputting determination information including a result of the determination.
